(19) United States
(12) Patent Application Publication
(10) Pub. No.: US 2011/0246921 A1
(43) Pub. Date: Oct. 6, 2011

(54) VISUALIZING SENTIMENT OF ONLINE CONTENT

(75) Inventors: Marc E. Mercuri, Bothell, WA (US); James O. Tisdale, Duvall, WA (US)

(73) Assignee: MICROSOFT CORPORATION, Redmond, WA (US)

(21) Appl. No.: 12/749,529

(22) Filed: Mar. 30, 2010

(51) Int. Cl. G06F 3/048

(52) U.S. Cl. 715/771; 715/764

(57) ABSTRACT

A sentiment visualization system provides a method for identifying content sentiment visually, and does so in a way that is also relevant to individuals who are colorblind. The system provides multiple visual cues that identify sentiment. In some embodiments, the visualization shows a bar that displays a color gradient. The color gradient is anchored by a positive color on one end and a negative color on the other end. The bar contains a color-neutral notch that represents where the sentiment value lies. The system may also allow a viewing user to reclassify an automatically determined sentiment of an item, such as by dragging a notch or other control on the visual display to a new location. Thus, the sentiment visualization system allows users to quickly sift through a large amount of content and identify high priority items for which a fast response is warranted.

### BACKGROUND

The Internet is filled with many different types of content, such as text, video, audio, and so forth. Many sources produce content, such as traditional media outlets (e.g., news sites), individual bloggers, retail stores, manufacturers of products, and so forth. Some web sites aggregate information from other sites. For example, using a Really Simple Syndication (RSS) feed, a web site author can make content available for other sites or users to consume, and an aggregating site can consume various RSS feeds to provide aggregated content.

Content publishers often provide a facility for rating content or receiving a sentiment about the content from a user (e.g., positive, negative, or some scale in between). For example, a video may include a display of five stars that a user can click on to rate the video from one to five stars. Publishers may also display a rating based on input from multiple users and use ratings in searches (e.g., to return the highest rated content or sort content by rating) or other workflows. Organizations may internally or externally rate content, such as determining which advertising campaign among several choices will be most effective for a target demographic. In the world of the real-time web, it is useful for organizations to receive contextually relevant evaluation of content.

One area where content sentiment may be determined is in protecting an organization's reputation. An organization's reputation may be one of the most important assets that the organization possesses. For example, a company's sales may be determined (in part) by how well customers trust the company to deliver products of a high quality and on time to the customer. Many customers determine whether they will deal with a particular business by how a customer service department of the business will handle things that go wrong (e.g., a missing shipment, damaged goods, and so on). Many organizations have built substantial reputations around the quality of their customer service and others have suffered due to negative impressions of their customer service. Customers may upload content to various sources that affects an organization's reputation.

Given the volume of data, an automated algorithm can evaluate the sentiment of most content to provide mixed success. Algorithms are typically trained on a generic result set, and therefore the interpretation of accuracy can vary widely when viewed in various contexts such as generational perception, geographic specific slang, geographic specific cultural beliefs, business verticals, and so forth. An organization may initially rate content automatically and then follow up with a manual process to tune the ratings or interpret what the ratings mean.

In the world of the real-time web, it is important for organizations to be able to understand the sentiment of content (positive and negative) so they can prioritize where they invest time responding. Given the volume of data to monitor, there is tremendous value in being able to identify the sentiment of a piece of content visually. Some solutions have tried to address the problem with a simple color approach (red for negative or green for positive), without sufficiently addressing the degree of positivity or negativity. In addition, prior approaches ignore individuals who suffer from color blindness, which is estimated at roughly 1 in 10 individuals.

### SUMMARY

A sentiment visualization system is described herein that provides a method for identifying content sentiment visually, and does so in a way that is also relevant to individuals who are colorblind. The system provides multiple visual cues that identify sentiment. In some embodiments, the visualization shows a bar that displays a color gradient. The color gradient is anchored by a positive color on one end and a negative color on the other end. The bar contains a color-neutral notch that represents where the sentiment value lies. The system may also allow a viewing user to reclassify an automatically determined sentiment of an item, such as by dragging a notch or other control on the visual display to a new location. Thus, the sentiment visualization system allows users to quickly sift through a large amount of content and identify high priority items for which a fast response is warranted.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the sentiment visualization, in one embodiment.

FIG. 2 is a flow diagram that illustrates processing of the sentiment visualization system to display a sentiment visualization, in one embodiment.

FIG. 3 is a flow diagram that illustrates processing of the sentiment visualization system to receive user interaction with a displayed sentiment visualization, in one embodiment.

FIG. 4 is a display diagram that illustrates two user interfaces associated with the sentiment visualization system, in one embodiment.

### DETAILED DESCRIPTION

A sentiment visualization system is described herein that provides a method for identifying content sentiment visually, and does so in a way that is also relevant to individuals who are colorblind. The system provides multiple visual cues that identify sentiment. For example, the system may include a displayed indicator that follows a scale of 0 to 1 and represents sentiment in several ways, such as a user-defined color scheme, hover text that provides a text description of the sentiment, and a notched bar (the placement of the notch on the bar is related to the sentiment value). In some embodiments, the visualization shows a bar that displays a color gradient. The color gradient is anchored by a positive color on one end and a negative color on the other end. The bar contains a notch that represents where the sentiment value lies between 0.0 and 1.0. When hovering over the bar with a mouse or other navigation instrument, a box is displayed that contains both textual description of the sentiment value (“Positive,” “Likely Positive,” “Neutral,” “Likely Negative,” “Negative”) and a numerical value for the percentage (e.g. 80%). The system may also allow a viewing user to reclassify an automatically determined sentiment of an item, such as by dragging a notch or other control on the visual display to a new location. Thus, the sentiment visualization system allows users, such as corporate representatives, to quickly sift through a large amount of content and identify high priority items for which a fast response is warranted.

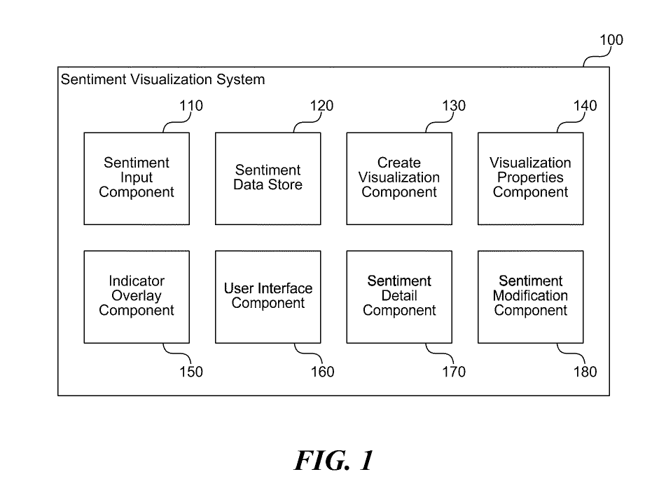

FIG. 1 is a block diagram that illustrates components of the sentiment visualization, in one embodiment. The system 100 includes a sentiment input component 110, a sentiment data store 120, a create visualization component 130, a visualization properties component 140, an indicator overlay component 150, a user interface component 160, a sentiment detail component 170, and a sentiment modification component 180. Each of these components is described in further detail herein.

The sentiment input component 110 receives a sentiment value for each of multiple content items. The sentiment value may be generated from a baseline evaluation component (not shown) that automatically determines a rating sentiment for a content item. The system 100 may use a variety of different automatic rating algorithms to develop a baseline rating for a content item. Users of the system 100 may tune the baseline rating by providing feedback about the accuracy of the automatic rating in the user's opinion. The baseline evaluation component may employ multiple automatic methods of rating content, and may combine the scores of multiple methods (e.g., averaging). The sentiment input component 110 stores the received sentiment values in the sentiment data store 120. The sentiment input component 110 may receive a stream of sentiment values for new content items as they are discovered by the system 100 or by external components that communicate with the system 100.

The sentiment data store 120 stores sentiment values for one or more content items. The data store 120 may include one or more disk drives, file systems, databases, storage area networks (SAN), cloud-based storage services, or other facilities for persisting data. For example, the system 100 may use a database that includes a table with rows that each stores a particular content item and sentiment value. Other components can query the sentiment data store 120 in various ways to extract information relevant to a particular report or other goal. For example, a component can query for content sentiment values to display a list of content items to a user along with sentiment information.

The create visualization component 130 creates one or more controls for displaying sentiment visualization information to a user. For example, the component 130 may create a slider bar or other visual representation to display a visualization value. The system 100 may display a vertical or horizontal list of content items (or content item summaries) that each includes a neighboring sentiment visualization that indicates the received sentiment of the neighboring content item.

The visualization properties component 140 modifies properties of displayed visualizations based on configuration settings. For example, an administrator may specify that negative sentiment values be displayed in red (or shades of red) and that positive sentiment values be displayed in green (or shades of green), or some other custom color scheme. The visualization properties component 140 may create a color gradient that gradually transitions from a selected positive color to a selected negative color using multiple intermediate shades in between. The visualization properties component 140 may also affect other properties, such as size (e.g., negative items larger in a topic cloud), font (e.g., bold text for certain items), transparency (e.g., lower priority items more transparent), highlighting (e.g., flashing high priority items), and so forth.

The indicator overlay component 150 overlays a non-color based visual indicator over the created visualization controls that allows colorblind users to view the sentiment visualization. For example, the component 150 may display a notch on one side of the visualization control, where the proximity of the notch to one end of the control or the other indicates whether the sentiment value is higher or lower (e.g., more positive or more negative). The component 150 can use any number of visual indications, such as a slider bar, progress bar, notch, or any other visually noticeable indication. In addition to benefiting colorblind users by making sentiment data easy to identify, the system also increases the speed with which all users can review sentiment information as multiple types of visual indication increase the chance that the user can peripherally process displayed information.

The user interface component 160 provides a user interface through which users of the system 100 can view sentiment visualizations and interact with displayed sentiment controls to receive detail information and update sentiment values. For example, the user interface may display content items to the user and provide a slider control next to each content item through which the user can specify his opinion of the content item (e.g., liked it, did not like it) on a scale. The user interface component 160 may also provide other controls, pages, or interfaces to the user for searching for content items, specifying profile and demographic information, receiving credit for rating content items, and so forth. When a user hovers over or otherwise selects a displayed sentiment control, the user interface component 160 may invoke the sentiment detail component 170 to provide additional details about the sentiment value.

The sentiment detail component 170 provides additional details about a sentiment value. For example, the sentiment detail component 170 may provide tooltip text that describes a sentiment value in additional detail in response to a user request for further information. The sentiment detail component 170 may provide information about the circumstances of the sentiment value. For example, the detail information may include demographic information of users that contributed to the sentiment value.

The sentiment modification component 180 receives input from a user to modify a displayed sentiment value. For example, a corporate representative reviewing potentially reputation-sensitive content on the Internet may perform an initial review of content item sentiment before forwarding the items on to a public relations (PR) representative for further processing. The corporate representative may assess whether a baseline sentiment assessment correctly reflects the priority and potential impact of the content item and if not, modify the content item sentiment to reflect a new priority or sentiment.

The computing device on which the sentiment visualization system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

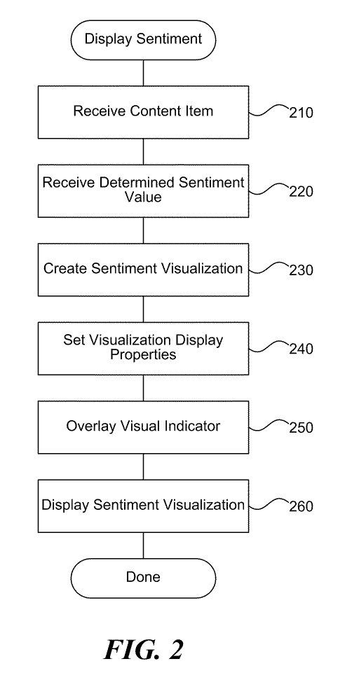

FIG. 2 is a flow diagram that illustrates processing of the sentiment visualization system to display a sentiment visualization, in one embodiment. Beginning in block 210, the system receives a content item for which to display a sentiment visualization. For example, the system may provide a list of content items for which the system will display sentiment visualizations in a list. The user may also select one or more content items or a source of content items for which to display sentiment visualizations.

Continuing in block 220, the system receives a determined sentiment value associated with the received content item. For example, upon receiving the content item the system may submit a database query to retrieve a stored sentiment value from a database. Alternatively or additionally, the system may provide the sentiment value in a data structure along with the content item. The sentiment value may include an automatically determined baseline sentiment as well as user or crowd-sourced modifications to the baseline sentiment. The sentiment may be filtered according to a particular target demographic or in other ways selected by the user.

Continuing in block 230, the system creates a sentiment visualization that visually conveys the sentiment value. The visualization may include one or more controls, such as a color gradient control, slider control, progress bar, and so forth that visually display the sentiment value. Typically the sentiment value is stored as a value between zero and one (although other values are possible, such as zero to 100), and the scale the control matches that of the sentiment value. The visualization may also display a text percentage where 100% is fully positive sentiment and 0% is fully negative sentiment.

Continuing in block 240, the system sets visualization display properties to enhance the sentiment visualization. Given the volume of data that a user may have to review, multiple visual cues about content item sentiment can help the user to more quickly deal with each content item. The system may set properties such as a color of the sentiment visualization (e.g., more red for negative sentiment and more green for positive sentiment, with blending for values in between), font, opacity, and so forth.

Continuing in block 250, the system overlays a visual indicator over the sentiment visualization that further conveys the sentiment value. For example, the system may overlay a notch along one edge of the sentiment visualization where the proximity of the notch to each end of the edge indicates how positive or negative the sentiment indicated by the sentiment value is. The visual indicator has less dependence on color and thus is more universally visible, such as to colorblind users. In addition, the overlaid visual indicator provides an additional cue to all users to help with quickly identifying sentiment values and reviewing content items based on sentiment.

Continuing in block 260, the system displays the sentiment visualization with the overlaid visual indicator. For example, the system may display a list of content items with visual sentiment information displayed beside each content item (e.g., a notched and color-coded bar to the left, right, top, or bottom of each content item). The display may allow the user to view a summary of the content item and to assess the sentiment of the content item in one glance. The display may also interact with the user's cursor position, such as by displaying additional sentiment detail when the user hovers over a content item or sentiment visualization. After block 260, these steps conclude.

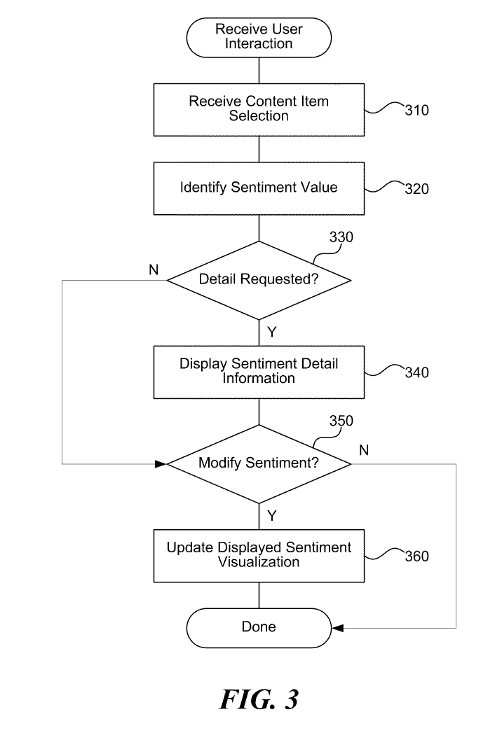

FIG. 3 is a flow diagram that illustrates processing of the sentiment visualization system to receive user interaction with a displayed sentiment visualization, in one embodiment. Beginning in block 310, the system receives a content item selection that identifies a content item among multiple content items with which a user requests interacting with sentiment information. For example, the user may click on a content item or hover over the item in a manner that indicates that the user wants further information about the item or wants to modify the item in some way.

Continuing in block 320, the system identifies a sentiment value associated with the received content item selection. For example, the user interface may include a data record that specifies a content item identifier and a sentiment value. The sentiment value indicates whether the content item is positive or negative with relations to particular subject matter, such as a company or product.

Continuing in decision block 330, if the system detects that the user is requesting detail information for the received content item and identified sentiment, then the system continues at block 340, else the system continues at block 350. The user interface may define a variety of actions that indicate that the user wants to receive more sentiment detail about a content item, such as hovering, pressing a keyboard combination, clicking the item, touching the item using a touch interface, and so forth.

Continuing in block 340, the system displays sentiment detail information for the received content item selection based on the identified sentiment value. For example, the detail information may provide a numeric value of the sentiment that coincides with the visual display, a further explanation of what the sentiment means, supplementary information about the sentiment, such as how it was determined (e.g., automatically, based on user feedback, and so forth), and so on.

Continuing in decision block 350, if the system determines that the user is requesting to modify the sentiment value, then the system continues at block 360, else the system completes. For example, the system may allow users to recharacterize a content item by modifying the item's sentiment value based on the visual indicator or sentiment visualization. For example, a user may click and drag a slider bar or notch on the displayed sentiment visualization to indicate that the user disagrees with the original sentiment value and wants to modify the value. The system stores the new sentiment value in the sentiment data store.

Continuing in block 360, the system updates the displayed sentiment visualization based on the determined user modifications. For example, if the user indicated that the content item was more positive than originally classified, then the system may change the color of the sentiment visualization and move the visual indicator to a more positive region of the visualization. Although shown serially, those of ordinary skill in the art will recognize that the above steps can be reordered and repeated to produce similar results. For example, a user may repeatedly hover over each item in the list, repeating steps 330 and 340 to view detail information about each item. After block 360, these steps conclude.

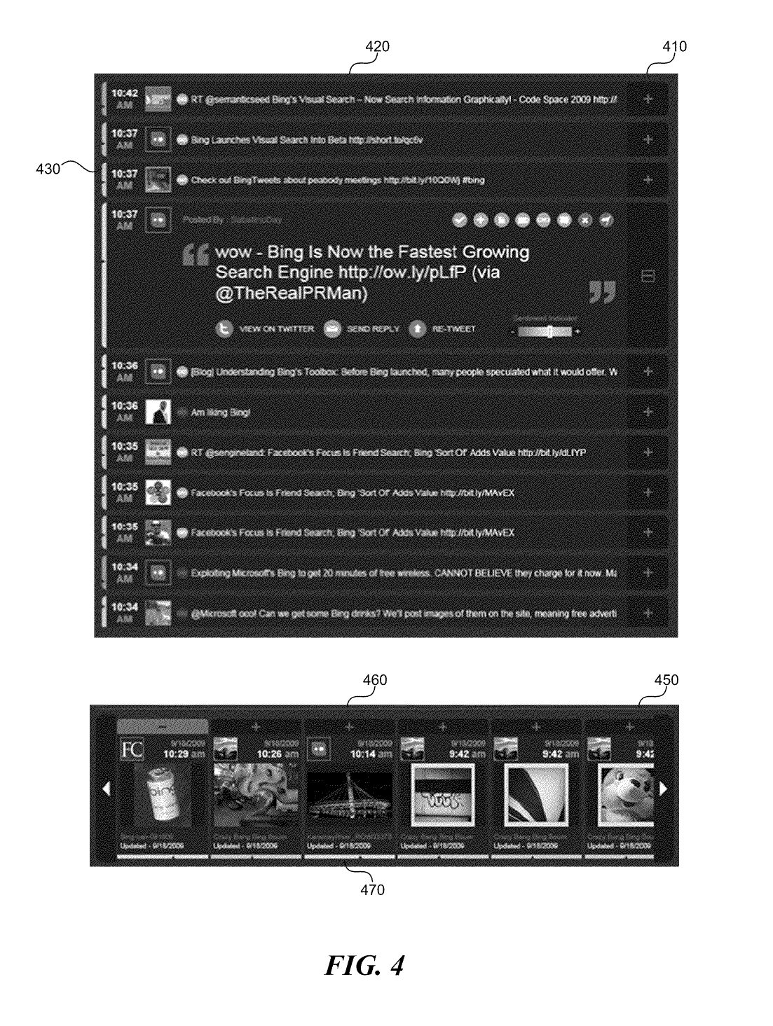

FIG. 4 is a display diagram that illustrates two user interfaces associated with the sentiment visualization system, in one embodiment. The diagram shows a display page 410 that includes a vertical list 420 of content items. Each content item includes displayable metadata with descriptive text or excerpts describing the content item. Each content item also includes a sentiment visualization 430. The sentiment visualization 430 has a color that varies between the positive and negative colors established for the control depending on the negativity or positivity, respectively, of the content item. The sentiment visualization 430 also includes a notch along the left side in this example that is further to the top for negative items and further to the bottom for positive items. The combination of color and the notch allows users to quickly get a read of whether the content item is potentially damaging and thus should receive a high priority response. The system is not limited to a single type of visual indication or to color-based visual indications that are not visible to users that are colorblind. The second display page 450 illustrates a horizontal list 460 of content items with a similar sentiment visualization 470 along the bottom of each content item. In this case, each sentiment visualization 470 includes a notch that varies from left to right based on the sentiment value.

In some embodiments, the sentiment visualization system is integrated into a larger software product for managing and responding to content itemsrelevant to brands, organizations, topics, or individuals. For example, a corporation may monitor buzz about their products and competitive products on the Internet through blog postings, search engine results, news stories, and so forth. The product may allow the user to use the system to visualize the sentiment of content and then respond to those content items that convey false information about the product, negative views about the product, or negative customer experiences with the product that can be turned positive through customer education. The corporation may use the system to respond to particular content items, such as by posting comments to blog posts or adding posts to forums that convey the corporation's point of view or respond to particular criticisms about a product. In some cases, the corporation may use the product to track feature requests or to respond to requests for features or needed bug fixes to make products better.

In some embodiments, the sentiment visualization system provides a data-reporting interface so that a user of the system or third parties can extract data from the system to perform further analysis. The system may store the created sentiment visualization in a bitmap, vector, or other format that allows data consumers to view the visualization and consume it along with content item data to produce sentiment reports and to prioritize items by sentiment as described herein.

In some embodiments, the sentiment visualization system includes configurable parameters that an administrator or other user can modify to alter behavior of the system. For example, the system may allow a user to set a custom color scheme or custom visual indicator for visualizing sentiment values in a manner preferred by the user. In addition, the system may store information about the user, such as whether the user is colorblind, to further ensure that indications displayed by the system are visible and useful to the user.

In some embodiments, the sentiment visualization system provides metadata for conveying sentiment of content items to visually impaired users. The control includes metadata for the sentiment that the system can provide to screen readers or other applications to allow users with other impairments to benefit from the same underlying architecture. Thus, the system can provide an audible cue when the user selects a content item as to that item's associated sentiment value.

From the foregoing, it will be appreciated that specific embodiments of the sentiment visualization system have been described herein for purposes of illustration, but that various modifications may be made without deviating from the spirit and scope of the invention. Accordingly, the invention is not limited except as by the appended claims.

I/we claim:

1. A computer-implemented method for displaying a visual sentiment indicator for online content, the method comprising:
receiving a content item for which to display the sentiment visualization;
receiving a determined sentiment value associated with the received content item;
creating a sentiment visualization that visually conveys the sentiment value to a user;
setting visualization display properties to indicate the sentiment value of the sentiment visualization;
overlaying a visual indicator over the sentiment visualization that conveys the sentiment value in a color-neutral manner; and
displaying the sentiment visualization with the overlaid visual indicator, wherein the preceding steps are performed by at least one processor.

2. The method of claim 1 wherein receiving the content item comprises receiving a list of content items to be displayed with sentiment visualizations in a graphical list.

3. The method of claim 1 wherein receiving the content item comprises receiving a selection from a user of one or more content items for which to display sentiment visualizations.

4. The method of claim 1 wherein receiving a determined sentiment value comprises upon receiving the content item, querying the sentiment value from a data store.

5. The method of claim 1 wherein receiving a determined sentiment value comprises receiving an automatically determined baseline sentiment value.

6. The method of claim 1 wherein receiving a determined sentiment value comprises receiving a sentiment value modified based on one or more user opinions.

7. The method of claim 1 wherein creating the sentiment visualization includes creating a control with a configurable color based on the determined sentiment value.

8. The method of claim 1 wherein setting visualization display properties comprises modifying a color of the visualization to display one color for positive sentiment, a second color for negative sentiment, and a blend of the two colors for sentiment in between, based on the determined sentiment value.

9. The method of claim 1 wherein overlaying the visual indicator comprises overlaying a notch along one edge of the sentiment visualization where the proximity of the notch to each end of the edge indicates how positive or negative the sentiment indicated by the sentiment value is.

10. The method of claim 1 wherein displaying the sentiment visualization comprises displaying a list of content items with visual sentiment information displayed beside each content item.

11. The method of claim 1 wherein displaying the sentiment visualization comprises displaying a summary of a content item adjacent to the sentiment visualization.

12. A computer system for visually indicating content item sentiment, the system comprising:
a processor and memory configured to execute software instructions;
a sentiment input component configured to receive a sentiment value for each of multiple content items;
a sentiment data store configured to store sentiment values for one or more content items;
a create visualization component configured to create one or more controls for displaying sentiment visualization information to a user;
a visualization properties component configured to modify properties of displayed visualizations based on configuration settings;
an indicator overlay component configured to overlay a non-color based visual indicator over the created visualization controls that allows colorblind users to view the sentiment visualization;
a user interface component configured to provide a user interface through which users can view sentiment visualizations and interact with displayed sentiment controls to receive detail information and update sentiment values;
a sentiment detail component configured to provide additional details about a sentiment value; and
a sentiment modification component configured to receive input from a user to modify a displayed sentiment value.

13. The system of claim 12 wherein the sentiment input component is further configured to receive a sentiment value automatically generated by a baseline evaluation component that automatically determines a rating sentiment for a content item.

14. The system of claim 12 wherein the sentiment input component is further configured to receive a stream of sentiment values for new content items as they are discovered by the system.

15. The system of claim 12 wherein the create visualization component is further configured to display a list of content items that each includes a neighboring sentiment visualization that indicates the received sentiment of the neighboring content item.

16. The system of claim 12 wherein the visualization properties component is further configured to set a color of the created sentiment visualization based on a positivity or negativity of the sentiment value.

17. The system of claim 12 wherein the indicator overlay component is further configured to display the visual indicator along one edge of the control so that the indicator's proximity to one end of the control or the other indicates whether the sentiment value is higher or lower.

18. A computer-readable storage medium comprising instructions for controlling a computer system to receive user interaction with a displayed sentiment visualization, wherein the instructions, when executed, cause a processor to perform actions comprising:
receiving a content item selection that identifies a content item among multiple content items with which a user requests interacting with sentiment information;
identifying a sentiment value associated with the received content item selection;
upon detecting that the user is requesting detail information for the received content item and identified sentiment, displaying sentiment detail information for the received content item selection based on the identified sentiment value; and
upon detecting that the user is requesting to modify the sentiment value, updating the displayed sentiment visualization based on the determined user modifications.

19. The medium of claim 18 wherein receiving the content item selection comprises receiving an indication that a user hovered a cursor over a content item.

20. The medium of claim 18 wherein updating the displayed sentiment visualization comprises updating a displayed visual indicator to indicate a new sentiment value in a manner that can be viewed by colorblind users.
